(19) United States
(12) Patent Application Publication
(10) Pub. No.: US 2005/0036563 A1
(43) Pub. Date: Feb. 17, 2005

(54) Wireless communication system for multi-carrier transmission, transmitter, transmission method, receiver, and reception method

(75) Inventors: Mitsuhiro Suzuki, Chiba (JP); Chihiro Fujita, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/880,515

(22) Filed: Jul. 1, 2004

(30) Foreign Application Priority Data
Jul. 4, 2003 (JP) 2003-271051

(51) Int. Cl. H04K 1/10

(52) U.S. Cl. 375/260

(57) ABSTRACT

The present invention aims at configuring a guard interval period so as to control out-of-band radiation and decrease a transmission power loss. A transmitter provides a repetition signal for a very short time period at both ends of an effective symbol and copies the repetition signal to opposite sides of the effective symbol. The transmitter then inserts a null signal corresponding to a guard interval time to remove intersymbol interference. Further, a transmission signal is multiplied by a window function for waveform shaping. A window function value is configured so as to always keep constant the sum of the window function value and itself shifted by an effective symbol length. This prevents the transmission symbol's energy from exceeding the energy for the effective symbol length before multiplication of the window function.

### BACKGROUND OF THE INVENTION

1. Field of the Invention

The present invention relates to a wireless communication system, a receiver, and a transmitter applicable to multi-path environments such as rooms where there are propagated a plurality of reflected waves and delayed waves including direct waves. Specifically, the present invention relates to a wireless communication system, a transmitter, a transmission method, a receiver, and a reception method so as to perform multi-carrier transmission by distributing transmission data into a plurality of carriers with different frequencies for the purpose of delay distortion solutions.

In more detail, the present invention concerns a wireless communication system, a transmitter, a transmission method, a receiver, and a reception method for performing multi-carrier transmission by providing a guard interval between transmission symbols to prevent intersymbol interference. Specifically, the present invention relates to a wireless communication system, a transmitter, a transmission method, a receiver, and a reception method for performing multi-carrier transmission by configuring a guard interval period so as to control out-of-band radiation and decrease a transmission power loss.

2. Description of Related Art

As computers are sophisticated, there is an increasing trend to connect a plurality of computers to constitute a LAN (Local Area Network) for sharing information such as files and data, sharing peripheral devices such as printers, and exchanging information such as transferring electronic mail and data.

A conventional LAN wiredly connects computers with each other using fiber optic cables, coaxial cables, or twisted pair cables. Such wired LAN requires construction works for connections, making the LAN construction difficult and resulting in complicated cabling. After the LAN is constructed, it has been inconvenient that the cable length limits the range of moving devices.

To solve this problem, special attention is paid to a wireless LAN as a system that frees users from cabling of conventional wired LANs. Such wireless LAN can eliminate most of cables from workspaces such as offices. Accordingly, it is possible to relatively easily move communication terminals such as personal computers (PCs).

In recent years, there is a remarkably increasing demand for wireless LAN systems as they achieve higher speeds and become available at reduced costs. Recently, introduction of a personal area network (PAN) is especially being considered to construct small-scale networks for information communication between electronic devices available around users.

Constructing an indoor wireless network forms the multi-path environment where a receiver receives a mixture of the direct wave and a plurality of reflected or delayed waves. A multi-path causes a delay distortion (or frequency selective fading) to generate a communication error. Intersymbol interference occurs due to the delay distortion.

The multi-carrier transmission system is a countermeasure against delay distortions. The multi-carrier transmission system transmits data by distributing it to a plurality of carriers having different frequencies. Each carrier is given a narrow band and is easily subject to effects of frequency selective fading.

For example, IEEE 802.11a, one of wireless LAN standards, uses the OFDM (orthogonal Frequency Division Multiplexing) system that is one of multi-carrier transmission systems. The OFDM system configures carrier frequencies so that the carriers are allocated orthogonally to each other in a symbol region. During information transmission, the system converts serially transmitted information into parallel information at a symbol frequency lower than the information transmission rate. The system allocates a plurality of pieces of output data to each carrier, modulates the amplitude and the phase for each carrier, and performs the inverse FFT for the carriers. In this manner, the system converts the carriers into signals in accordance with the time axis by maintaining the orthogonality of each carrier in accordance with the frequency axis. The reception occurs in the reverse order of the transmission. The system performs the FFT to convert signals along the time axis into those along the frequency axis and demodulates the carriers in accordance with the modulation of each carrier. The system performs parallel-serial conversion to reproduce the information that was originally transmitted in the serial signals.

The OFDM transmission system can increase the symbol length by using a plurality of orthogonal subcarriers. The OFDM transmission system is resistant to multi-paths. If a multi-path component exists, however, a delayed wave affects the next symbol, causing intersymbol interference. Further, there occurs an interference between subcarriers (inter-carrier interference), degrading reception characteristics.

To solve this problem, there has been conventionally used a method of providing a guard interval between transmission symbols to eliminate intersymbol interference. That is to say, guard signals such as a guard interval and a guard band are inserted between transmission symbols in accordance with a specified guard interval size, guard band size, and timing.

It is a general practice to repeatedly transmit part of a transmission signal as the guard signal (e.g., see non-patent document 1). Inserting a repetition signal into the guard interval period discards multi-path propagation (propagation of multiple reflection waves) below the guard interval size. This can remove interference between subcarriers and prevent the reception quality from being degraded fatally. The use of a repetition signal for the guard interval provides an advantage of being capable of synchronization between symbol timings or frequencies. By contrast, if no repetition signal is inserted into the guard interval, the signal-noise ratio decreases (e.g., see non-patent document 2).

If the wireless transmission is subject to an increase in the radiation power outside the signal band, this causes large interference with channels or other systems that use the band.

The OFDM transmission uses filters or a method of multiplying a signal along the time axis by a window function. An example of the latter window function is to attenuate both ends of a symbol using cosine waveforms (e.g., see non-patent document 3). However, the restriction of bands loses part of the energy for transmission symbols. If the multi-carrier transmission configures the guard interval period using a null signal, extra energy such as the repetition signal is not transmitted. Multiplication of a window function attenuates both ends of an effective symbol to reduce the energy for reception symbols.

[Non-patent document 1] Tadashi Siomi, et al. “Digital Broadcasting.” Ohmsha, Ltd., 1998.

[Non-patent document 2] R. Morrison, et al. “On the Use of a Cyclic Extension in OFDM” (0-7803-7005-8/$10.00 IEEE, 2001)

[Non-patent document 3] S. B. Weinstein. “Data Transmission by Frequency-Division Multiplexing Using the Discrete Fourier Transform” (IEEE TRANSACTIONS ON COMMUNICATION TECHNOLOGY, VOL. COM-19, NO. 5, OCTOBER 1971)

### SUMMARY OF THE INVENTION

It is therefore an object of the present invention to provide a wireless communication system, a transmitter, a transmission method, a receiver, and a reception method capable of preferable multi-carrier transmission by providing a guard interval between transmission symbols so as to prevent intersymbol interference.

Another object of the present invention is to provide a wireless communication system, a transmitter, a transmission method, a receiver, and a reception method capable of preferable multi-carrier transmission by configuring a guard interval period so as to suppress out-of-band radiation and decrease transmission power loss.

The present invention has been made in consideration of the foregoing. According to one aspect of the present invention, there is provided a wireless communication system for multi-carrier transmission,
wherein a transmitter adds a repetition signal, inserts a guard interval including a null signal, and then multiplies a window function before and/or after an effective symbol of a transmission signal; and
wherein a receiver uses a signal component overflowing an effective symbol of a reception signal to perform waveform shaping for a signal component at the beginning and/or the end of the effective symbol.

The term “system” signifies a logical aggregate of a plurality of apparatuses or function modules to realize specific functions. No consideration is given to whether or not each apparatus or function module is contained in a single cabinet.

The transmitter multiplies a transmission signal by a window function so as to always keep almost constant the sum of the window function and itself shifted by an effective symbol length. The window function is configured so as to attenuate from both ends of an effective symbol as centers and is given full-cosine rolloff characteristic, for example.

The receiver performs waveform shaping by adding a signal component forward and backward overflowing an effective symbol of a reception signal to respective opposite sides of an effective symbol portion.

The multi-carrier transmission such as OFDM generally inserts a guard interval between transmission symbols to solve the problem of intersymbol interference under a multi-path environment.

A repetition signal comprises part of the operation device. Inserting the repetition signal in to the guard interval period discards multi-path propagation below the guard interval size. This can remove interference between subcarriers and prevent the reception quality from being degraded fatally. When a repetition signal is inserted into the guard interval period, however, the receiver removes such repetition portion, causing a drawback of increasing a transmission power loss.

A possible solution is to insert a null signal instead of the repetition signal into the guard interval. This can suppress the transmission power per unit frequency in the signal band. However, there is a drawback of increasing the radiation power outside the signal band, causing large interference with channels or other systems that use the corresponding band.

According to the present invention, the transmitter suppresses out-of-band radiation and configures the guard interval period for signal transmission so as to decrease transmission power losses. More specifically, the transmitter provides a repetition signal for a very short time period at both ends before and after an effective symbol length and copies the repetition signal to opposite sides of the effective symbol. The transmitter then inserts a null signal corresponding to a guard interval time to remove intersymbol interference. After the guard interval is inserted into the transmission signal, this signal is multiplied by a window function for waveform shaping. A window function value is configured so as to always keep constant the sum of the window function value and itself shifted by an effective symbol length. This prevents the transmission symbol's energy from exceeding the energy for the effective symbol length before multiplication of the window function.

The transmitter configures the window function so as to attenuate from both ends of an effective symbol as centers. The transmission energy in the effective symbol also decreases. The total energy for the transmission symbol becomes smaller than the transmission energy in the effective symbol before the repetition signal is added.

A receiver compensates the decreased transmission energy. More specifically, the receiver uses a signal component overflowing an effective symbol of a reception signal to perform waveform shaping for a signal component at the beginning and end of the effective symbol. An example of the waveform shaping is to add a signal component forward and backward overflowing the effective symbol to respective opposite sides of the effective symbol portion. Of the overflowing signal components, portions for the repetition signal are added in the same phase to recover the signal energy attenuated by the transmitter's window function. Delay wave components become contiguous in the effective symbol to eliminate inter-subcarrier interference.

According to the present invention, the transmitter adds a repetition signal before and after the effective symbol and then multiplies a minimum window function. This makes it possible to decrease out-of-band radiation power without increasing transmission symbol energy.

The receiver adds a signal component overflowing the effective symbol portion to the opposite effective symbol portion. This can prevent signal energy from decreasing due to a window function and prevent inter-subcarrier interference from occurring due to a delay wave.

As preprocessing for waveform shaping, the receiver multiplies the reception symbol by a coefficient that simply increases corresponding to an average reception SN ratio for respective samples. This can improve the reception symbol's SN ratio.

Other and further objects, features, and advantages of the present invention will be apparent from the following description of embodiments with reference to the accompanying drawings.

The present invention can provide a wireless communication system, a transmitter, a transmission method, a receiver, and a reception method capable of preferable multi-carrier transmission by configuring a guard interval period so as to suppress out-of-band radiation and decrease transmission power loss.

According to the present invention, a transmitter adds a repetition signal before and after an effective symbol and then multiplies a minimum window function during multi-carrier transmission. This makes it possible to decrease out-of-band radiation power without increasing transmission symbol energy.

A receiver adds a signal component overflowing an effective symbol portion to the opposite effective symbol portion. This can prevent signal energy from decreasing due to a window function and prevent inter-subcarrier interference from occurring due to a delay wave.

As preprocessing for waveform shaping, the receiver multiplies a reception symbol by a coefficient corresponding to an average reception SN ratio for respective samples. This can improve the reception symbol's SN ratio.

### BRIEF DESCRIPTION OF THE DRAWINGS

FIG. 1 schematically shows the functional configuration of an OFDM transmitter according to an embodiment of the present invention;

FIG. 2 schematically shows the configuration of a transmission signal where a guard interval is inserted;

FIG. 3 shows an example of a waveform-shaped transmission signal;

FIG. 4 schematically shows the functional configuration of an OFDM receiver according to the embodiment of the present invention;

FIG. 5 schematically shows operation characteristics in a waveform shaping section 43;

FIG. 6 illustrates a method of solving a noise power problem after adding a portion overflowing an effective symbol portion due to the use of extra transmission energy in the transmitter;

FIG. 7 schematically shows the functional configuration of an OFDM receiver to improve a reception SN ratio in accordance with propagation path situations;

FIG. 8 schematically shows preprocessing of waveform shaping; and

FIG. 9 exemplifies the relationship between an average reception SN ratio and a coefficient multiplied by a reception symbol.

### DETAILED DESCRIPTION OF THE PREFERRED EMBODIMENTS

Embodiments of the present invention will be described in further detail with reference to the accompanying drawings.

The present invention relates to a communication system using the OFDM system expected to be the technology that provides high-speed and high-quality wireless transmission. The OFDM system is one of multi-carrier transmission systems and configures carrier frequencies so that the carriers are allocated orthogonally to each other within a symbol region. A high-speed signal is divided into many subcarriers for transmission. As a result, a subcarrier alone is transmitted at a low speed. Accordingly, the system is resistant to interference of delayed waves.

The OFDM transmission system provides a guard interval between transmission symbols to solve the problem of intersymbol interference under the multi-path environment. The system inserts guard signals such as a guard interval and a guard band into each transmission symbol in accordance with a specified guard interval size, guard band size, and timing.

It is a general practice to repeatedly transmit part of a transmission signal to the guard interval period. Inserting a repetition signal into the guard interval period discards multi-path propagation below the guard interval size. This can remove interference between subcarriers and prevent the reception quality from being degraded fatally. The use of a repetition signal for the guard interval provides an advantage of being capable of synchronization between symbol timings or frequencies.

When a repetition signal is inserted into the guard interval period, the receiver removes such repetition portion. In other words, the repetition portion does not contribute to the receiver as signal power. Therefore, there is such a problem that inserting the repetition signal increases the transmission power.

Further, inserting the repetition signal increases the transmission symbol length. There is a problem of causing inter-carrier interference to transmission signals. The inter-carrier interference increases the transmission power per unit frequency. When the transmission power per unit frequency is legally restricted, the transmission power needs to be decreased for the increased amount, causing the SN ratio to be degraded.

On the other hand, it is possible to insert a null signal instead of the repetition signal into the guard interval. When the multi-carrier transmission uses the guard interval period including a null signal, no inter-carrier interference occurs on transmission signals. Accordingly, such multi-carrier transmission can suppress the transmission power per unit frequency in the signal band compared to the multi-carrier transmission that uses the repetition signal for the guard interval. However, there is a drawback of increasing the radiation power outside the signal band, causing large interference with channels or other systems that use the corresponding band.

According to the present invention, the transmitter suppresses out-of-band radiation and configures the guard interval period for signal transmission so as to decrease transmission power losses. The receiver receives signals so as to prevent the signal energy from decreasing and prevent the inter-carrier interference from occurring due to a delay wave.

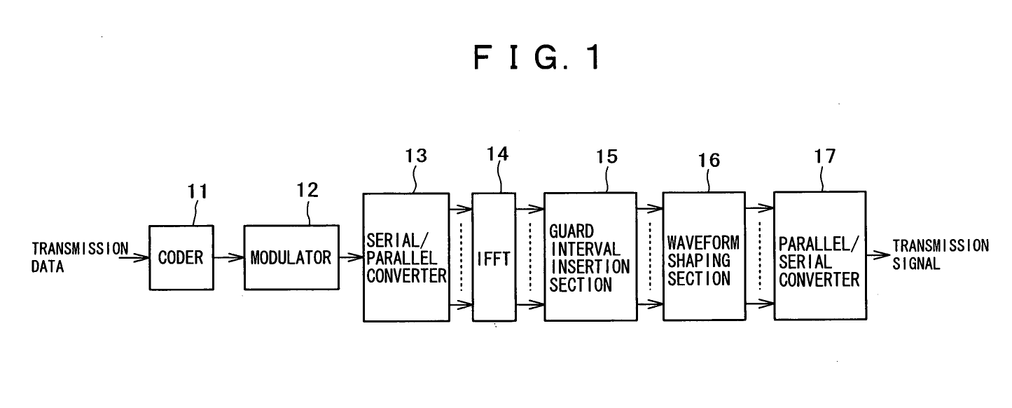

FIG. 1 schematically shows the functional configuration of an OFDM transmitter according to an embodiment of the present invention. As shown in FIG. 1, the OFDM transmitter comprises a coder 11, a modulator 12, a serial/parallel converter 13, an IFFT 14, a guard interval insertion section 15, a waveform shaping section 16, and a parallel/serial converter 17.

The coder 11 encodes transmission data using an error correction code. When supplied with transmission data, the modulator 12 performs QPSK modulation, for example, according to modulation information and timing supplied from a transmission control section 109. The QPSK (Quadrature Phase Shift Keying) is one of phase modulation systems as digital modulation systems and maintains the correspondence between the 0 phase and (0,0), between the π/2 phase and (0,1), between the π phase and (1,0), and between the 3/π phase and (1,1).

After modulation of the transmission data, it may be preferable to insert a known data series as a pilot symbol into a modulation symbol series according to a pilot symbol insertion pattern and the timing. A pilot signal comprising a known pattern is inserted at an interval of each subcarrier or several subcarriers.

The serial/parallel converter 13 converts the modulated serial signal into parallel data equivalent to the number of parallel carriers for aggregation according to the number of parallel carriers and the timing.

The IFFT 14 performs inverse Fourier transform equivalent to the FFT size according to a specified FFT size and the timing.

The guard interval insertion section 15 provides a guard interval period before and after one OFDM symbol to eliminate intersymbol interference. The time range for the guard interval is determined by a propagation path situation, that is to say, the delay wave's maximum delay time that affects the demodulation. The delay time is included in the guard interval. The embodiment inserts a repetition signal or a null signal into the guard interval period. The guard interval may be provided only before or after the OFDM symbol. The configuration of the guard interval period will be described later in more detail.

The waveform shaping section 16 shapes a waveform at one or both ends of a signal where the guard interval is inserted. For example, the waveform shaping process decreases the out-of-band radiation power by multiplying a specified window function, for example. The waveform shaping process will be described later in more detail.

Finally, the parallel/serial converter 17 converts the signal into a serial signal as a transmission signal in accordance with the time axis by maintaining the orthogonality of each carrier in accordance with the frequency axis.

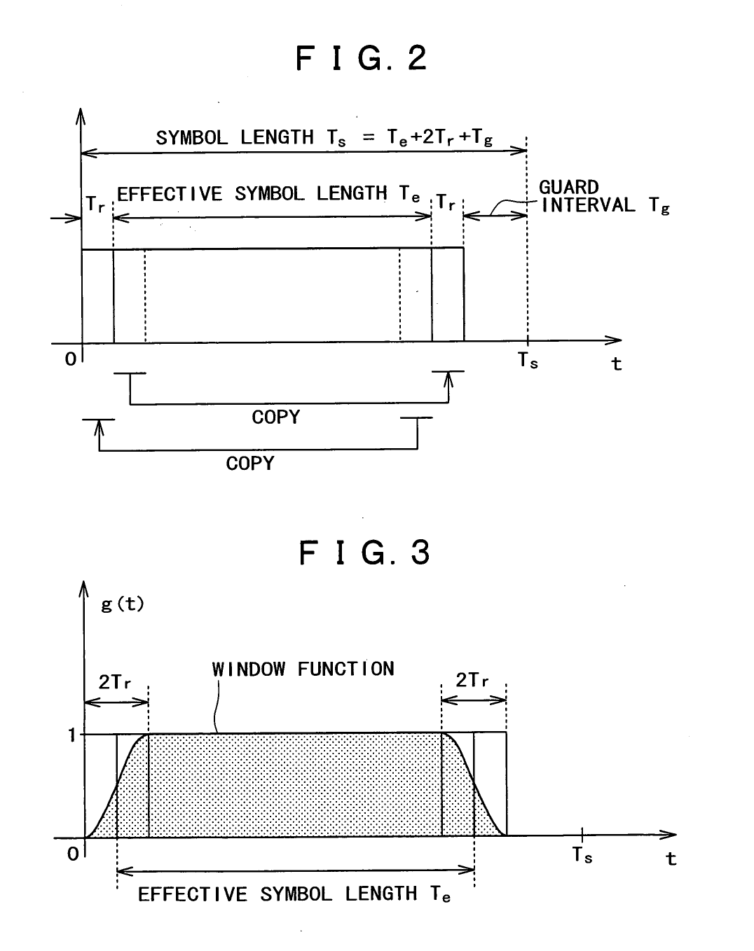

FIG. 2 schematically shows the configuration of a transmission signal. As shown in FIG. 2, the guard interval insertion section 15 inserts a guard interval for every one OFDM symbol. It is assumed that the signal inversely Fourier transformed by the IFFT corresponds to effective symbol length Te in FIG. 2. There is found a signal equivalent to time Tr at the ends before and after the effective symbol length. This signal is copied to the opposite side of the effective symbol. The signal is referred to as a repetition signal. Thereafter, a null signal is inserted correspondingly to guard interval Tg to remove the intersymbol interference. The repetition signal and the guard interval can be inserted either before or after the effective symbol as well as before and after the effective symbol as shown in FIG. 2.

As mentioned above, time Tr corresponds to the repetition signal to be copied to both ends of the symbol. If Tr is set to 0, the guard interval completely comprises a null signal. Since the repetition signal causes a transmission power loss, shortening Tr is considered to be preferable. On the other hand, if the guard interval period completely comprises a null signal, the radiation power increases outside the signal band.

Consequently, symbol length Ts is expressed in the following equation, assuming that the repetition signal is copied to both ends of the effective symbol length.
Tₛ=Tₑ+2Tᵣ+T_{g} [Equation 1]

The waveform shaping section 16 performs waveform shaping for a transmission signal after insertion of the guard interval to suppress the radiation poweroutside the signal band. The embodiment shapes waveforms by multiplying a function called the window function.

FIG. 3 shows an example of a waveform-shaped transmission signal. FIG. 3 provides an example window function that uses a cosine waveform to attenuate both ends of the symbol. The use of the cosine waveform provides advantages of ability to remove inter-carrier interference, cause a small transmission power loss, and the like.

A window function value is configured so as to always keep constant the sum of the window function value and itself shifted by an effective symbol length. Such configuration prevents the transmission symbol's energy from exceeding the energy for the effective symbol length before multiplication of the window function. Let us assume that window function values are set to 1 for the effective symbol portion and to 0s for the other portions. This signifies that no repetition signal is added to the symbol and a null signal is inserted into the guard interval.

FIG. 3 shows that a window function value is set so as to attenuate from the beginning and end of the effective symbol length for preceding and succeeding Tr times. This example limits a higher harmonic wave and decreases the out-of-band radiation power.

The following equation provides an example window function g(t) when the repetition signal and the guard interval are inserted as shown in FIG. 2. The equation below is given the full-cosine rolloff characteristic. Therefore, transmission signals are free from inter-subcarrier interference. In addition, it is possible to decrease the out-of-band radiation power.

$$g ( t ) = \{ \begin{matrix}\frac{1}{2} [ 1 + cos \frac{π ( t - 2 {T}_{r} )}{2 {T}_{r}} ] , & 0 \leq t < 2 {T}_{r} \\ 1 , & 2 {T}_{r} \leq t < {T}_{e} \\ \frac{1}{2} [ 1 + cos \frac{π ( t - 2 {T}_{e} )}{2 {T}_{r}} ] , & {T}_{e} \leq t < {T}_{e} + 2 {T}_{r} \\ 0 , & ( other periods than the above )\end{matrix} \qquad [ Equation 2 ]$$

The prior art inserts repetition signals into all guard interval periods and generally configures window functions so as not to attenuate in the effective symbol portion. The purpose is to prevent the reception symbol energy from decreasing. On the other hand, as shown in FIG. 3, the system according to the present invention configures window functions so as to attenuate from both ends of the effective symbol as centers. Therefore, the transmission energy in the effective symbol also decreases. The total energy for the transmission symbol becomes smaller than the transmission energy in the effective symbol before the repetition signal is added. The receiver can compensate the decreased transmission energy. This will be described in detail later.

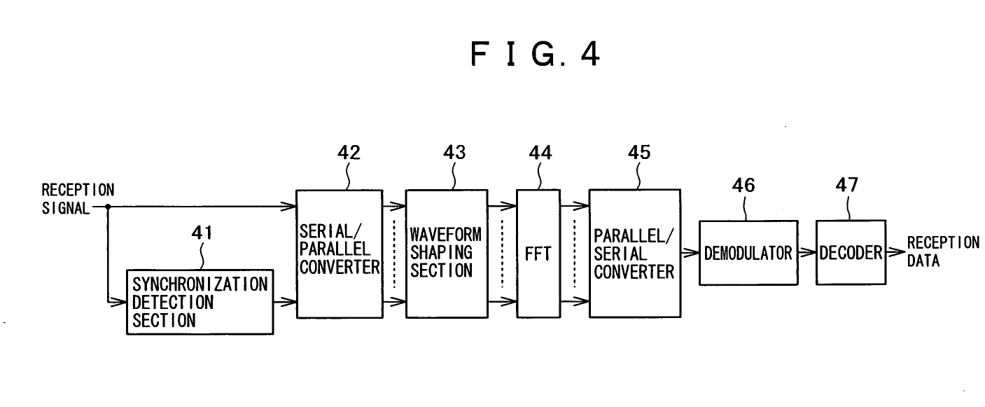

FIG. 4 schematically shows the functional configuration of an OFDM receiver according to the embodiment of the present invention. As shown in FIG. 4, the OFDM receiver comprises a synchronization detection section 41, a serial/parallel converter 42, a waveform shaping section 43, an FFT 44, a parallel/serial converter 45, a demodulator 46, and a decoder 47.

The synchronization detection section 41 detects synchronization timing from a reception signal subject to multi-path fading on the propagation path. The synchronization detection section 41 detects the synchronization using a preamble signal.

The serial/parallel converter 42 converts the reception signal as serial data into parallel data for aggregation in accordance with the detected synchronization timing. The serial/parallel converter 42 aggregates the signal equivalent to one OFDM symbol including up to the guard interval.

The waveform shaping section 43 then shapes a waveform of the signal including up to the guard interval into a waveform of the effective symbol. Accordingly, it is necessary to preserve the waveform of the signal including up to the guard interval. Operations of the waveform shaping section 43 will be described in detail later.

The FFT 44 Fourier transforms the signal equivalent to an effective symbol length to extract a signal for each subcarrier. Then, the parallel/serial converter 45 converts the time-axis signal into the frequency-axis signal. The demodulator 46 demodulates the signal according to QPSK, for example. The decoder 47 decodes the signal to yield reception data.

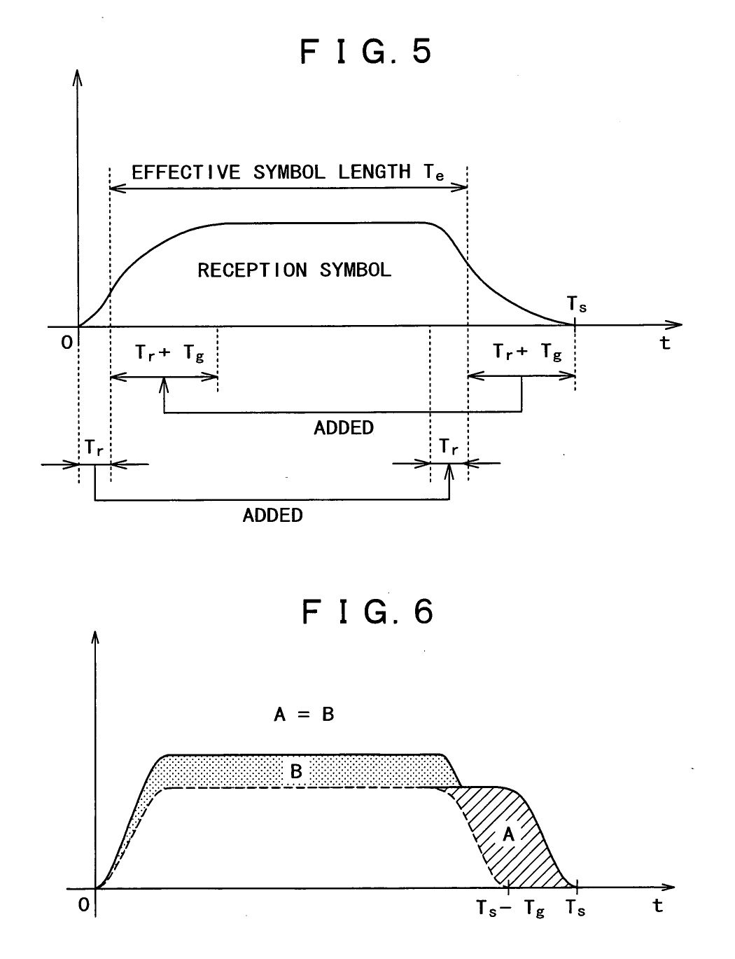

FIG. 5 schematically shows operation characteristics in the waveform shaping section 43. Multi-paths on the propagation path distort the waveform of the reception symbol as shown in FIG. 5. It is assumed that the maximum delay time for the delay wave does not exceed guard interval Tg. In this case, the delay wave does not overlap the next symbol, causing no intersymbol interference. However, let us consider supplying the FFT 44 directly with the reception symbol's effective symbol portion (the range up to guard interval Tg in FIG. 5). In this case, a delay wave results from the window function and the propagation path during transmission and causes inter-subcarrier interference to occur, greatly degrading reception characteristics.

According to the embodiment as shown in FIG. 5, the waveform shaping section 43 adds signal components overflowing from the reception symbol's effective symbol portion to opposite sides of the effective symbol portion. When the effective symbol portion is extracted as shown in FIG. 5, the Tr+Tg portion at the end is added to the beginning of the effective symbol. The Tr portion at the beginning is added to the end thereof. After the addition, the signal for the effective symbol portion is extracted and is input to the FFT 44. At this time, portions for the repetition signal are added in the same phase to recover the signal energy attenuated by the transmitter's window function. Delay wave components become contiguous in the effective symbol to eliminate inter-subcarrier interference.

FIG. 5 shows portions overflowing from the effective symbol portion. Totaling all of the overflowing portions invites a problem of increasing the noise power.

A possible solution for this problem is to use extra transmission energy in the transmitter. This method is described with reference to FIG. 6.

A conventional transmission signal uses the repetition signal inserted into the guard interval period and increases the transmission energy equivalent to a guard interval indicated by A in FIG. 6. To solve this problem, the system according to the present invention allocates the extra energy to a portion indicated by B in FIG. 6 other than the null signal. It becomes possible to provide a reception SN ratio based on the same transmission power as the conventional method. That is to say, controlling the transmitter removes differences in the decoding performance at the receiver.

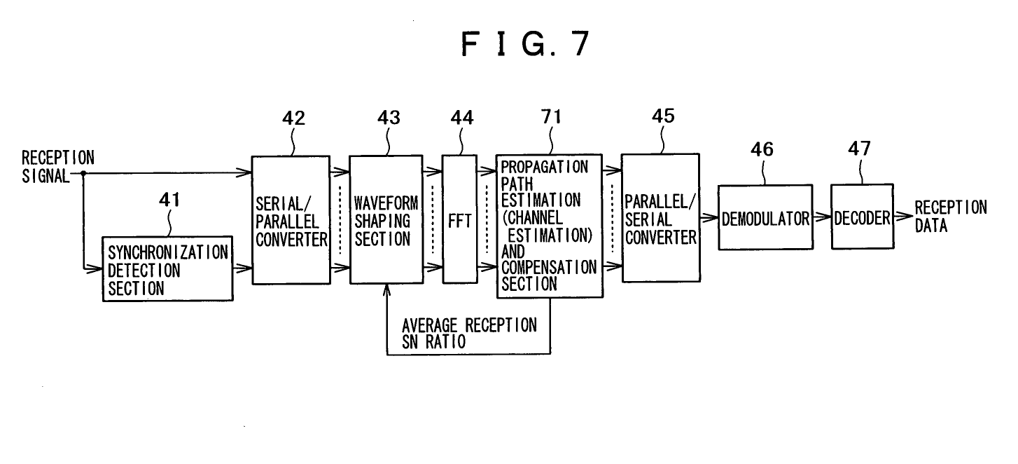

Another possible solution for the problem is to improve the reception SN ratio in accordance with propagation path situations. FIG. 7 schematically shows the functional configuration of an OFDM receiver to improve the reception SN ratio in accordance with propagation path situations. This receiver differs from the receiver of FIG. 4 in that a propagation path estimation (channel estimation) and compensation section is added.

A preamble or a pilot symbol comprising a known pattern is inserted into the transmitter. The pilot symbol is inserted at an interval of each subcarrier or several subcarriers. The propagation path estimation (channel estimation) and compensation section 71 specifies the propagation path for compensation based on a reception signal for the preamble or the pilot symbol. This section concurrently obtains an average reception SN ratio for samples of the reception symbol. A waveform shaping section 43 uses this average reception SN ratio to provide preprocessing for the waveform shaping.

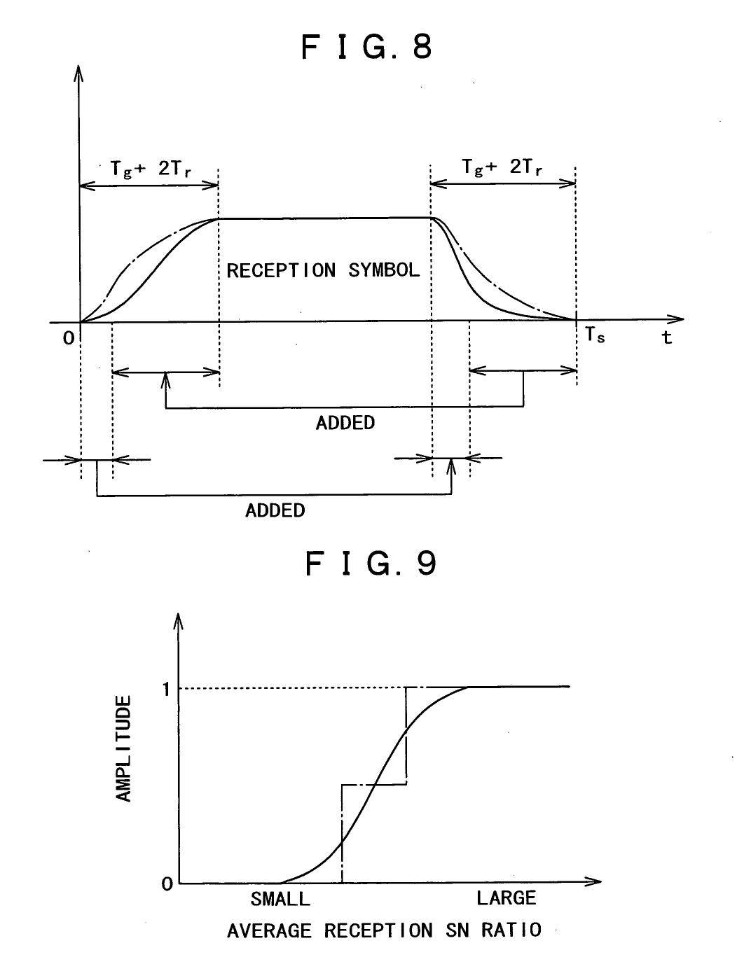

FIG. 8 schematically shows preprocessing of waveform shaping. In FIG. 8, the reception symbol is depicted with a dot-dash line. If a portion overflowing the effective symbol is added straightly, the noise energy is also added as mentioned above. The SN ratio degrades. If the addition is omitted, the noise energy does not increase. While the effective symbol portion is input to the FFT 44, the signal energy for the portion decreases. In addition, inter-subcarrier interference occurs. The former noise energy depends on noise power such as a thermal noise. The latter two depend on signal energy.

As a solution, when a sample has a large average reception SN ratio, the reception symbol is multiplied by a coefficient that approximates 1 and does not exceed 1. When a sample has a small expected SN ratio, the reception symbol is multiplied by a coefficient that approximates 0 and is not smaller than 0. In this manner, it is possible to improve the reception SN ratio. A solid line in FIG. 8 depicts the reception symbol after the preprocessing.

FIG. 9 exemplifies the relationship between an average reception SN ratio and a coefficient multiplied by a reception symbol. As shown in FIG. 9, the coefficient is greater than or equal to 0 and is smaller than or equal to 0. The coefficient is assumed to be a value that straightly increases in accordance with the average reception SN ratio. The coefficient may be a discrete value in order to simplify the calculation. The dot-dash line in FIG. 8 shows an example of using three discrete values for the coefficients.

[Supplement]

There has been described the present invention with reference to the specific embodiment. However, it is further understood by those skilled in the art that various changes and modifications may be made in the embodiment without departing from the spirit and scope of the present invention. That is to say, the present invention has been disclosed in the form of exemplification. The contents of this specification must not be interpreted limitedly. The spirit and scope of the invention should be judged in consideration for the appended claims.

1. A wireless communication system for multi-carrier transmission,
wherein a transmitter adds a repetition signal, inserts a guard interval including a null signal, and then multiplies a window function before and/or after an effective symbol of a transmission signal; and
wherein a receiver uses a signal component overflowing an effective symbol of a reception signal to perform waveform shaping for a signal component at the beginning and/or the end of said effective symbol.

2. The wireless communication system according to claim 1,
wherein said transmitter multiplies a transmission signal by a window function so as to always keep almost constant the sum of said window function and itself shifted by an effective symbol length.

3. The wireless communication system according to claim 2,
wherein said window function is configured so as to attenuate from both ends before and after an effective symbol as centers.

4. The wireless communication system according to claim 2,
wherein said window function is given full-cosine rolloff characteristic.

5. The wireless communication system according to claim 1,
wherein said receiver performs waveform shaping by adding a signal component forward and backward overflowing an effective symbol of a reception signal to respective opposite sides of an effective symbol portion.

6. The wireless communication system according to claim 1,
wherein said receiver performs preprocessing for waveform shaping by multiplying a reception symbol by a specified coefficient.

7. The wireless communication system according to claim 6,
wherein a value which is greater than or equal to 0 and smaller than or equal to 1 and increases simply in accordance with an average SN ratio for reception sample points.

8. A transmitter to transmit a multi-carrier signal,
wherein said transmitter adds a repetition signal, inserts a guard interval including a null signal, and then multiplies a window function so as to always keep almost constant the sum of said window function and itself shifted by an effective symbol length before and/or after an effective symbol of a transmission signal for waveform shaping.

9. A transmitter to transmit a multi-carrier signal comprising:
signal processing means for coding and modulating transmission data;
serial/parallel conversion means for converting a modulated signal into parallel data equivalent to the number of parallel carriers;
inverse Fourier transform means for performing inverse Fourier transform said parallel data equivalent to an FFT size in accordance with a specified FFT size and timing to convert data into a time-axis signal;
guard interval insertion means for adding a repetition signal to before and/or after an effective symbol of a transmission signal and inserting a guard interval including a null signal;
waveform shaping means for performing waveform shaping by multiplying a window function by a transmission signal where a guard interval is inserted; and
parallel/serial conversion means for converting a transmission signal into a serial signal as a transmission signal according to a time axis by maintaining orthogonality of each carrier according to a frequency axis.

10. The transmitter according to claim 8 or 9,
wherein transmission signal is multiplied by a window function so as to always keep almost constant the sum of said window function and a value shifted by an effective symbol length.

11. The transmitter according to claim 8 or 9,
wherein said window function is configured so as to attenuate from both ends of the effective symbol as centers.

12. The transmitter according to claim 8 or 9,
wherein said window function is given full-cosine rolloff characteristic.

13. A transmission method of transmitting a multi-carrier signal comprising the steps of:
adding a repetition signal, inserting a guard interval including a null signal, and then multiplying a window function so as to always keep almost constant the sum of said window function and itself shifted by an effective symbol length before and/or after an effective symbol of a transmission signal for waveform shaping.

14. A transmission method of transmitting a multi-carrier signal comprising:
a signal processing step of coding and modulating transmission data;
a serial/parallel conversion step of converting a modulated signal into parallel data equivalent to the number of parallel carriers;
an inverse Fourier transform step of performing inverse Fourier transform said parallel data equivalent to an FFT size in accordance with a specified FFT size and timing to convert data into a time-axis signal;
a guard interval insertion step of adding a repetition signal to before and/or after an effective symbol of a transmission signal and inserting a guard interval including a null signal;
a waveform shaping step of performing waveform shaping by multiplying a window function by a transmission signal where a guard interval is inserted; and
a parallel/serial conversion step of converting a transmission signal into a serial signal as a transmission signal according to a time axis by maintaining orthogonality of each carrier according to a frequency axis.

15. The transmission method according to claim 13 or 14,
wherein a transmission signal is multiplied by a window function so as to always keep almost constant the sum of said window function and a value shifted by an effective symbol length.

16. The transmission method according to claim 13 or 14,
wherein said window function is configured so as to attenuate from both ends before and after an effective symbol as centers.

17. The transmission method according to claim 13 or 14,
wherein said window function is given full-cosine rolloff characteristic.

18. A receiver to receive multi-carrier transmission signal
wherein said receiver uses a signal component overflowing an effective symbol of a reception signal to perform waveform shaping for a signal component at the beginning and/or the end of said effective symbol.

19. A receiver to receive a multi-carrier transmission signal comprising:
synchronization detection means for detecting synchronization timing from a reception signal;
serial/parallel conversion means for converting a serial reception signal into parallel data equivalent to the number of parallel carriers in accordance with detected synchronization timing to obtain a reception symbol;
waveform shaping means for using a signal component overflowing an effective symbol of a reception signal to perform waveform shaping for a signal component at the beginning and/or the end of said effective symbol;
Fourier transform means for Fourier transforming a signal equivalent to an effective symbol length to extract a signal for each subcarrier;
parallel/serial conversion means for converting a reception signal into a serial signal as a reception signal according to a time axis by maintaining orthogonality of each carrier according to a frequency axis; and
signal processing means for demodulating and decoding a reception signal to obtain reception data.

20. The receiver according to claim 18 or 19,
wherein said waveform shaping means performs waveform shaping by adding a signal component forward and backward overflowing an effective symbol of a reception signal to respective opposite sides of an effective symbol portion.

21. The receiver according to claim 18 or 19,
wherein said waveform shaping means performs preprocessing for waveform shaping by multiplying a reception symbol by a specified coefficient.

22. The receiver according to claim 21,
wherein said waveform shaping means sets a coefficient to be multiplied by a reception symbol to a value which is greater than or equal to 0 and smaller than or equal to 1 and increases simply in accordance with an average SN ratio for reception sample points.

23. The receiver according to claim 22 further comprising:
a propagation path estimation (channel estimation) and compensation section to estimate and compensate a propagation path based on a specified reception signal and concurrently obtain an average reception SN ratio for samples of a reception symbol during propagation path estimation.

24. A reception method of receiving a multi-carrier transmission signal comprising the step of:
using a signal component overflowing an effective symbol of a reception signal to perform waveform shaping for a signal component at the beginning and/or the end of said effective symbol.

25. A reception method of receiving a multi-carrier transmission signal comprising:
a synchronization detection step of detecting synchronization timing from a reception signal;
a serial/parallel conversion step of converting a serial reception signal into parallel data equivalent to the number of parallel carriers in accordance with detected synchronization timing to obtain a reception symbol;
a waveform shaping step of using a signal component overflowing an effective symbol of a reception signal to perform waveform shaping for a signal component at the beginning and/or the end of said effective symbol;
a Fourier transform step of Fourier transforming a signal equivalent to an effective symbol length to extract a signal for each subcarrier;
a parallel/serial conversion step of converting a reception signal into a serial signal as a reception signal according to a time axis by maintaining orthogonality of each carrier according to a frequency axis; and
a signal processing step of demodulating and decoding a reception signal to obtain reception data.

26. The reception method according to claim 24 or 25,
wherein said waveform shaping step performs waveform shaping by adding a signal component forward and backward overflowing an effective symbol of a reception signal to respective opposite sides of an effective symbol portion.

27. The reception method according to claim 24 or 25,
wherein said waveform shaping step performs preprocessing for waveform shaping by multiplying a reception symbol by a specified coefficient.

28. The reception method according to claim 27,
wherein said waveform shaping step sets a coefficient to be multiplied by a reception symbol to a value which is greater than or equal to 0 and smaller than or equal to 1 and increases simply in accordance with an average SN ratio for reception sample points.

29. The reception method according to claim 28 further comprising:
a propagation path estimation (channel estimation) and compensation section to estimate and compensate a propagation path based on a specified reception signal and concurrently obtain an average reception SN ratio for samples of a reception symbol during propagation path estimation.
